(19) United States
(12) Patent Application Publication
(10) Pub. No.: US 2019/0221904 A1
(43) Pub. Date: Jul. 18, 2019

(54) HEAT TRANSFER MEMBER, BATTERY PACK, AND VEHICLE

(71) Applicant: Toyota Jidosha Kabushiki Kaisha, Toyota-shi Aichi-ken (JP)

(72) Inventor: Aki Fujii, Toyota-shi Aichi-ken (JP)

(21) Appl. No.: 16/243,391

(22) Filed: Jan. 9, 2019

(30) Foreign Application Priority Data
Jan. 15, 2018 (JP) 2018-004277

(51) Int. Cl. H01M 10/653; H01M 2/10; H01M 10/613; H01M 10/625

(52) U.S. Cl. CPC H01M 10/653; H01M 10/625; H01M 10/613; H01M 2/1077

(57) ABSTRACT

Provided is a heat transfer member excellent in vibration resistance and a battery pack in which cooling efficiency is effectively prevented from decreasing due to a vibration, A heat transfer member for a battery pack including a battery stack, a heat transfer member, and a cooler that are brought into contact in this order. The heat transfer member includes: rubber particles; and a resin having heat conductivity higher than that of the rubber particles.

### CROSS REFERENCE TO RELATED APPLICATIONS

This application is based upon and claims the benefit of priority from Japanese patent application No. 2018-004277, filed on Jan. 15, 2018, the disclosure of which is incorporated herein in its entirety by reference.

### BACKGROUND

The present disclosure relates to a heat transfer member, a battery pack, and a vehicle.

A battery pack having a battery stack has been cooled with, for example, air in order to prevent overheating due to heat generated in the battery stack. On the other hand, along with an increase in the output power of the battery pack, cooling by a cooler is being studied.

For example, Japanese Unexamined Patent Application Publication No. 2013-033668 discloses a configuration in which a cooling plate is provided on bottom surfaces of a plurality of prismatic battery cells fixed in a stacked state, and an insulating heat conductive sheet is disposed between the plurality of prismatic battery cells and the cooling plate.

### SUMMARY

In order to cool the battery stack by the cooler, it is necessary to have a contact area between the battery stack and the cooler. When the battery stack and the cooler are arranged with the heat transfer member disposed therebetween, it is necessary to have a contact area between the heat transfer member and the battery stack and between the heat transfer member and the cooler.

The battery stack is composed of a plurality of stacked battery cells. For manufacturing reasons, there may be many projections and recesses on the cooling surface of the battery stack. As a result of intensive studies from such a viewpoint, the present inventor has found that by use of a resin heat transfer member as the heat transfer member, it is possible to have a contact area even for the battery stack including some projections and recesses.

On the other hand, when a battery pack including a battery stack disposed on a resin heat transfer member is installed in a vehicle or the like, a force exceeding the weight of the battery stack may be instantaneously applied to the heat transfer member by a vibration. At this time, the heat transfer member may be crushed, and the deformation generated by the crush may not be fully restored even after the force is relieved. As a result, there is sometimes a part where the battery stack and the heat transfer member are not brought into contact with each other, which reduces the cooling efficiency.

The present disclosure has been made in view of the above circumstances. An object of the present disclosure to provide a heat transfer member excellent in vibration resistance, a battery pack in which cooling efficiency is effectively prevented from decreasing due to a vibration, and a vehicle including the battery pack.

An exemplary aspect of the present disclosure is a heat transfer member for a battery pack including a battery stack, a heat transfer member, and a cooler that are brought into contact with each other in this order. The heat transfer member includes: rubber particles; and a resin having heat conductivity higher than that of the rubber particles.

Another exemplary aspect of the present disclosure is a battery pack including: a battery stack; a heat transfer member; and a cooler. The heat transfer member includes rubber particles and a resin having higher heat conductivity than that of the rubber particles.

Another exemplary aspect of the present disclosure is a vehicle including a battery pack that includes a battery stack, a heat transfer member, and a cooler that are brought into contact with each other in this order. The heat transfer member includes rubber particles and a resin having higher heat conductivity than that of the rubber particles.

According to the present disclosure, it is possible to provide a heat transfer member excellent in vibration resistance, a battery pack in which cooling efficiency is effectively prevented from decreasing due to a vibration, and a vehicle including the battery pack.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is an exploded perspective view showing a schematic configuration of a battery pack which is an example of a battery pack according to an embodiment;

FIG. 2 is a schematic cross-sectional view showing an example of a layer structure of the battery pack according to this embodiment; and

FIG. 3 is a schematic cross-sectional view showing an example of a heat transfer member according to this embodiment.

### DESCRIPTION OF EMBODIMENTS

Hereinafter, a heat transfer member, a battery pack, and a vehicle according to this embodiment will be described. The following descriptions and drawings are omitted and simplified as appropriate for the sake of clarity. The same elements are denoted by the same signs throughout the drawings, and repeated descriptions will be omitted as necessary. Note that the right-handed xyz coordinates shown in the drawings are for the convenience of explaining the positional relationship of the components.

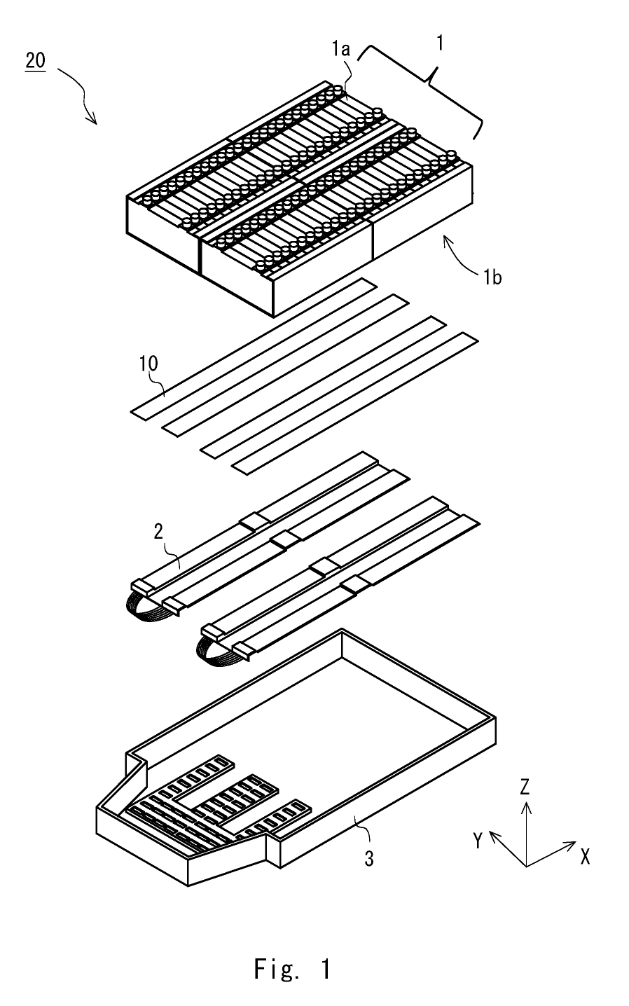

First, a schematic configuration of a battery pack according to this embodiment will be described with reference to the drawings. FIG. 1 is an exploded perspective view showing a schematic configuration of a battery pack 20 which is an example of the battery pack according to this embodiment. As shown in FIG. 1, the battery pack 20 includes a battery stack 1, a heat transfer member 10, and a cooler 2 in this order. The battery pack 20 may include a lower case 3 for accommodating these components as necessary. The battery pack 20 may further include other components as necessary without losing the effect of the present disclosure.

Another example of the components is a heater used, for example, at the time of activating the battery under a low temperature environment. The heater is provided, for example, between the lower case 3 and the cooler 2 (not shown).

The battery stack 1 is composed of a plurality of stacked battery cells 1a. In the example of FIG. 1, the battery cells la are stacked in an X-axis direction and electrically connected in series by a known manner. The configuration of the battery cell is not particularly limited. The battery cell may be a secondary battery such as a lithium ion battery and a nickel hydrogen battery or may be a fuel cell.

The cooler 2 cools the battery stack 1 and is disposed on at least one side of the battery stack 1. In the example of FIG. 1, the cooler 2 is disposed on the bottom surface side of the battery stack 1. The bottom surface of the battery stack 1 is a cooled surface 1b.

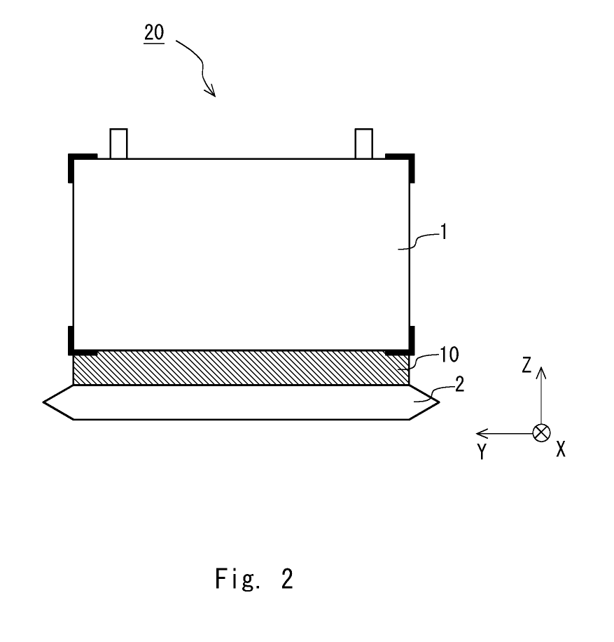

FIG. 2 is a schematic cross-sectional view showing an example of a layer structure of the battery pack 20 according to this embodiment. As shown in FIG. 2, after assembly, in the battery pack 20, the battery stack 1 and the heat transfer member 10 are brought into contact with each other, and the heat transfer member 10 and the cooler 2 are brought into contact with each other. Heat generated in the battery stack 1 is transferred to the cooler 2 via the heat transfer member 10, and the battery stack 1 is cooled.

The cooler 2 is not particularly limited. The cooler 2 may be, for example, a heat sink or a member including a coolant flow path. In some embodiments, in terms of cooling efficiency, the cooler 2 is a member including a coolant flow path. When the cooler 2 is a member including a coolant flow path, the flow path is connected to a cooling apparatus that supplies the coolant by a known manner.

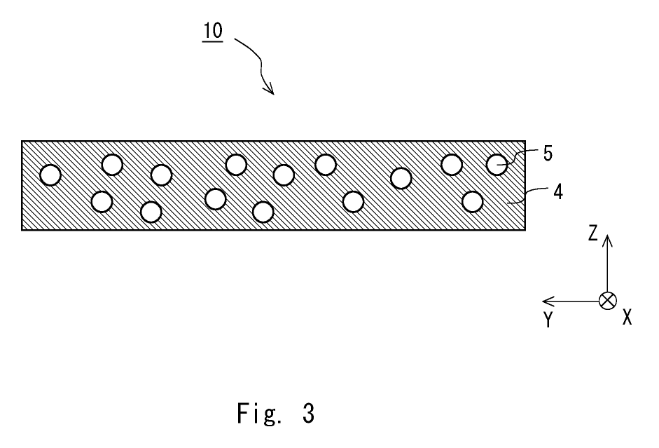

FIG. 3 is a schematic cross-sectional view showing an example of the heat transfer member according to this embodiment. In this embodiment, the heat transfer member 10 includes rubber particles 5 and a resin 4 having higher thermal conductivity than that of the rubber particles 5. This specific heat transfer member 10 is excellent in vibration resistance, which effectively prevents the cooling efficiency of the battery pack from decreasing due to a vibration.

The resin 4 included in the heat transfer member 10 according to this embodiment can ensure that there is a contact area conforming to a shape of the cooled surface 1b even when there are some projections and recessions on the cooled surface 1b of the battery stack 1. Further, the rubber particles 5 included in the heat transfer member 10 according to this embodiment enable the battery stack 1 to be kept in contact with the heat transfer member 10, because even when the heat transfer member 10 is deformed by a change in the load applied to the heat transfer member 10 due to a vibration, the heat transfer member 10 can be easily restored from the deformation. Furthermore, the particulate rubber combined with the resin 4 having high thermal conductivity in the heat transfer member 10 according to this embodiment can effectively prevent the thermal conductivity from decreasing by the property of the rubber.

As described above, the heat transfer member 10 according to this embodiment is excellent in vibration resistance, and the cooling efficiency of the battery pack using the heat transfer member 10 is prevented from decreasing due to a vibration.

The heat transfer member 10 of the present embodiment includes at least the resin 4 and the rubber particles 5, and may further contain other components as long as there is no deterioration in the object of the present disclosure.

In this embodiment, the resin can be appropriately selected from resins having higher thermal conductivity than that of rubber particles, which will be described later. The resin may be a thermoplastic resin or a three-dimensionally crosslinked resin. In some embodiments, a three-dimensionally crosslinked resin is used in terms of mechanical strength and the like. An example of the three-dimensionally crosslinked resin is a cured product of a curable resin. The resin may be any of a photo-curable resin, a thermosetting resin, and a two-component mixed curable resin. Further, in some embodiments, the resin has elasticity to conform to the projections and recessions on the cooled surface 1b of the battery stack 1.

Examples of such a resin include a silicone resin, an acrylic resin, and an epoxy resin. A silicone resin or an acrylic resin is among the above resins in terms of thermal conductivity. A silicone resin or an epoxy resin is among the above resins in terms of shape conformability. In some embodiments, the silicone resin is a two-component mixed curable resin in terms of ease of handling at the time of production.

In this embodiment, the rubber particles are particulate substances baying higher elastic modulus than that of the resin. Because of the rubber particles included in the heat transfer member, the heat transfer member is excellent in shape restorability, and the thermal conductivity between the battery stack and the cooler is can be maintained even when the heat transfer member is crushed by a vibration or the like.

In some embodiments, the rubber constituting the rubber particles is a polymer having a chain structure. The polymer may be the one in which a crosslinked structure by sulfur or the like is partially formed.

In some embodiments, a thermosetting elastomer is used as the rubber, because it has excellent elasticity. Examples of the thermosetting elastomer include diene-based synthetic rubber such as polyisoprene rubber, polybutadiene rubber, styrene-butadiene rubber, polychloroprene rubber, nitrile rubber, and ethylene-propylene rubber; ethylene-propylene rubber, butyl rubber, acrylic rubber, polyurethane rubber, non-diene-based synthetic rubber such as ethylene-propylene rubber, butyl rubber, acrylic rubber, polyurethane rubber, fluorine rubber, silicone rubber, epichlorohydrin rubber; and natural rubber. In some embodiments, diene-based synthetic rubber is used among the above-listed rubbers. In sonic other embodiments, styrene-butadiene rubber is used among the diene-based synthetic rubbers.

In this embodiment, the average primary particle diameter of the rubber particles is not particularly limited. In some embodiments, the average primary particle diameter of the rubber particles is 50 nm or greater and 500 nm or less, and 100 nm or greater and 400 nm or less.

The average primary particle diameter can be calculated by a method of directly measuring the sizes of primary particles using an electron micrograph. Specifically, the short axis diameter and the long axis diameter of each primary particle are measured, and an average of the short and long axis diameters of the primary particle is used as a particle diameter of this particle. An average value of the particle diameters of 20 or more particles is used as the average primary particle diameter.

In this embodiment, a content ratio of the rubber particles in the heat transfer member is not particularly limited. However, in terms of vibration resistance, the ratio of the rubber particles to the total amount of the heat transfer member is 1 mass % or more, 4 mass % or more, or 5 mass % or more. On the other hand, in terms of thermal conductivity, the ratio of the rubber particles to the total amount of the heat transfer member is 25 mass % or less, 22 mass % or less, 20 mass % or less, or 15 mass % or less.

In this embodiment, the method of forming the heat transfer member is not particularly limited, and a known method can be used. Examples of the known methods include (1) a method in which a resin composition including a curable resin, rubber particles, and, as necessary, a solvent and the like is prepared, the resin composition is applied to a cooler, and, as necessary, heated or irradiated with light so that the resin composition is cured; and (2) a method in which a sheet for a heat transfer member including a resin and rubber particles is formed on a releasable substrate and the sheet is attached to a cooler.

In this embodiment, the thickness of the heat transfer member is not particularly limited. However, in terms of mechanical strength against a vibration or the like, the thickness of the heat transfer member is 1 mm or greater, or 3 mm or greater. Moreover, in terms of thermal conductivity, the thickness of the heat transfer member is 10 nm or less, or 8 mm or less.

In the battery pack according to this embodiment, the cooling efficiency of the battery pack is prevented from decreasing due to a vibration, because it includes the above-described heat transfer member according to this embodiment. Thus, the battery pack according to this embodiment may be used for a member that is susceptible to a vibration, and may be used for, for example, a battery pack for a vehicle.

### EXAMPLES

Hereinafter, the heat transfer member according to this embodiment will be described in more detail using examples. Note that the present disclosure is not limited by the descriptions of the examples.

### Example 1

Styrene-butadiene rubber (SBR) having a particle diameter of 167 nm was added to a two-component mixed type curable silicone resin so as to achieve 3.5 mass %, mixed using a static mixer, and discharged by a dispenser on a cooler to obtain a heat transfer member having a thickness of 5 mm and a width of 30 mm.

### Example 2

The heat transfer members according to Examples 2 to 6 were obtained in the same manner as in Example 1 except that a content ratio of SBR in Example 1 was changed as shown in Table 1 below.

### Comparative Example 1

A heat transfer member according to Comparative Example 1 was obtained in the same manner as in Example 1 except that in Comparative Example 1, SBR was not added.

### <Vibration Resistance Evaluation>

A battery stack was mounted and fixed on each of the heat transfer members according to Examples and Comparative Examples. Next, a vibration that applies three times the gravity (3G) was given to the heat transfer member for 15 minutes. After the vibration, the battery stack was removed from the heat transfer member, the bottom of the stack was observed, and the ratio of the area of the part where the heat transfer member did not adhere to the area where the heat transfer member was in contact was calculated. The calculated values are shown in Table 1 as non-contact area ratios. It was evaluated that, regarding the part where no electrothermal member was adhered, the heat transfer member was peeled off from the stack due to the vibration.

### <Evaluation of Thermal Conductivity Rate>

A heat transfer member having the same composition as those in the above Examples 1 to 6 and Comparative Example 1 and having a thickness of 5 mm and a diameter of 33 mm was prepared. A thermal conductivity rate of this heat transfer member was measured by a steady-state method in accordance with ASTM D5470. Specifically, a thermal resistance measurement apparatus (TIM Tester 1400) heat transfer member was sandwiched between a cooling plate and a heater, and the thermal conductivity rate was measured from a change in a temperature difference between upper and lower parts of the heat transfer member. The results are shown in Table 1.

TABLE 1

| | SBR | Thermal | Non-contact |
|---|---|---|---|
| | Content | conductivity rate | area ratio |
| | Ratio [wt %] | [W/m · K] | [%] |
| Comparative | 0 | 3.67 | 80 |
| Example 1 | | | |
| Example 1 | 3.5 | 3.67 | 30 |
| Example 2 | 5 | 3.66 | 8 |
| Example 3 | 10 | 3.67 | 3 |
| Example 4 | 15 | 3.66 | 0 |
| Example 5 | 20 | 3.25 | 0 |
| Example 6 | 25 | 1.87 | 0 |

### Summary of Results

Evaluation results of the thermal conductivity rate reveal that even when particulate rubber was added to the resin, the thermal conductivity barely decreases. In particular, when the content ratio of the rubber particles was 20 mass % or less, the same thermal conductivity rate as that of Comparative Example 1 in which no particles were added was achieved. From the vibration resistance evaluation result, in Comparative Example 1 in which no rubber particles were added, it was found that the heat transfer member was peeled off and the cooling efficiency was reduced when the non-contact area ratio of the battery stack is at 80%. On the other hand, in Examples 1 to 6, the electrothermal member was less peeled, showing that the cooling efficiency was excellent even when the vibration was given.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A heat transfer member for a battery pack including a battery stack, a heat transfer member, and a cooler that are brought into contact with each other in this order, the heat transfer member comprising:
rubber particles; and
a resin having heat conductivity higher than that of the rubber particles.

2. A battery pack comprising:
a battery stack;
a heat transfer member; and
a cooler, wherein
the battery stack, the heat transfer member, and the cooler are brought into contact with each other in this order, and
the heat transfer member includes rubber particles and a resin having higher heat conductivity than that of the rubber particles.

3. A vehicle comprising a battery pack including a battery stack, a heat transfer member, and a cooler that are brought into contact with each other in this order, wherein the heat transfer member includes rubber particles and a resin having higher heat conductivity than that of the rubber particles.

4. The battery pack according to claim 2, wherein a content ratio of the rubber particles is 20 mass % or less.

5. The battery pack according to claim 2, wherein a content ratio of the rubber particles is 15 mass % or less.

6. The battery pack according to claim 4, wherein the content ratio of the rubber particles is 5 mass % or less.
